(19) United States
(12) Patent Application Publication
(10) Pub. No.: US 2010/0098847 A1
(43) Pub. Date: Apr. 22, 2010

(54) Drop Deposition Materials for Imprint Lithography

(75) Inventor: Van Nguyen Truskett, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/580,692

(22) Filed: Oct. 16, 2009

Related U.S. Application Data
(60) Provisional application No. 61/107,007, filed on Oct. 21, 2008.

(51) Int. Cl. B05D 5/10; C08L 83/00; B29D 11/00

(52) U.S. Cl. 427/207.1; 524/858; 264/1.25

(57) ABSTRACT

A fluid for dispensation on a substrate. In one implementation, the fluid comprises a set of fluid parameters to facilitate dispensation of the fluid from the system. In another implementation, the fluid comprises a set of fluid parameters specific to a polymerizable material.

### CROSS-REFERENCE TO RELATED APPLICATIONS

This application claims the benefit under 35 U.S.C. §119(e)(1) of U.S. Provisional No. 61/107,007, filed Oct. 21, 2008, which is hereby incorporated by reference.

### BACKGROUND INFORMATION

Nano-fabrication includes the fabrication of very small structures that have features on the order of 100 nanometers or smaller. One application in which nano fabrication has had a sizeable impact is in the processing of integrated circuits. The semiconductor processing industry continues to strive for larger production yields while increasing the circuits per unit area formed on a substrate; therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent, includes formation of a relief pattern in a polymerizable layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF SEVERAL VIEWS OF THE DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of a lithographic system in accordance with an embodiment of the present invention.

FIG. 2 illustrates a simplified side view of the substrate shown in FIG. 1 having a patterned layer positioned thereon.

FIG. 3 illustrates a simplified side view of a fluid dispensing system dispensing droplets on a substrate.

FIG. 4 illustrates a simplified side view of an exemplary fluid dispensing system.

FIG. 5 illustrates a flow chart of an exemplary method for dispensing droplets of fluid to prevent clogging of the nozzle system.

FIG. 6 illustrates a flow chart of an exemplary method for the passivation of a dispense head in fluid dispensing system.

FIG. 7 illustrates a simplified side view of droplets egressing from tips of the fluid dispense system of FIG. 4.

### DETAILED DESCRIPTION

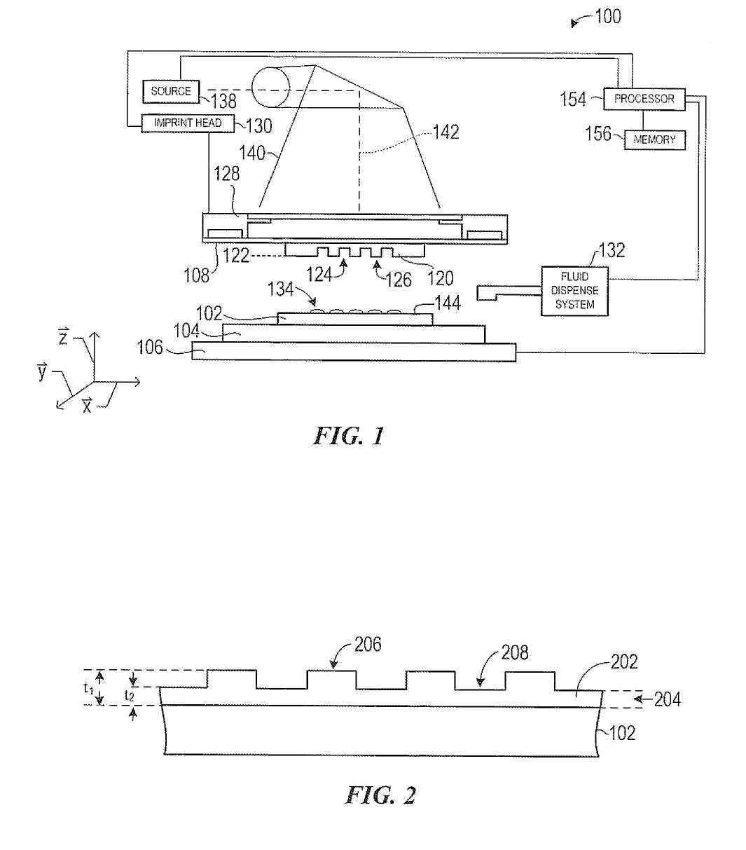

Referring to the figures, and particularly to FIG. 1, illustrated therein is a lithographic system 100 used to form a relief pattern on substrate 102. Substrate 102 may be coupled to substrate chuck 104. In one implementation, substrate chuck 104 is a vacuum chuck. Alternatively, substrate chuck 104 may be any chuck including, but not limited to, a vacuum, a pin-type, a groove-type, an electromagnetic, and/or the like. Exemplary chucks are described in U.S. Pat. No. 6,873,087, which is hereby incorporated by reference.

Substrate 102 and substrate chuck 104 may be further supported by stage 106. Stage 106 may provide motion along the x-, y-, and z-axes. Stage 106, substrate 102, and substrate chuck 104 may also be positioned on a base (not shown).

Spaced-apart from substrate 102 is a template 108. Template 108 includes a mesa 120 extending therefrom towards substrate 102, mesa 120 having a patterning surface 122 thereon. Further, mesa 120 may be referred to as mold 120. Template 108 and/or mold 120 may be formed materials including, but not limited to, fused-silica, quartz, silicon, organic polymers, siloxane polymers, borosilicate glass, fluorocarbon polymers, metal, hardened sapphire, and/or the like. As illustrated, patterning surface 122 comprises features defined by a plurality of spaced-apart recesses 124 and/or protrusions 126, though embodiments of the present invention are not limited to such configurations. Patterning surface 122 may define any original pattern that forms the basis of a pattern to be formed on substrate 102.

Template 108 may be coupled to chuck 128. Chuck 128 may be configured as, but not limited to, vacuum, pin-type, groove-type, electromagnetic, and/or other similar chuck types. Exemplary chucks are further described in U.S. Pat. No. 6,873,087, which is hereby incorporated by reference. Further, chuck 128 may be coupled to imprint head 130 such that chuck 128 and/or imprint head 130 may be configured to facilitate movement of template 108.

System 100 may further comprise a fluid dispensing system 132. Fluid dispensing system 132 may be used to deposit fluid 134 on substrate 102. Fluid 134 may be positioned upon substrate 102 using techniques such as, but not limited to, drop dispense, spin-coating, dip coating, chemical vapor deposition (CVD), physical vapor deposition (PVD), thin film deposition, thick film deposition, and/or the like. Fluid 134 may be disposed upon substrate 102 before and/or after a desired volume is defined between mold 120 and substrate 102 depending on design considerations. Fluid 134 may comprise a monomer as described in U.S. Pat. No. 7,157,036 and U.S. Patent Publication No. 2005/0187339, all of which are hereby incorporated by reference.

Referring to FIGS. 1 and 2, system 100 may further comprise an energy source 138 coupled to direct energy 140 along path 142. Imprint head 130 and stage 106 may be configured to position template 108 and substrate 102 in superimposition with path 142. System 100 may be regulated by a processor 154 in communication with stage 106, imprint head 130, fluid dispensing system 132, and/or source 138, may operate on a computer readable program stored in memory 156.

Either imprint head 130, stage 106, or both vary a distance between mold 120 and substrate 102 to define a desired volume therebetween that is filled by fluid 134. For example, imprint head 130 may apply a force to template 108 such that mold 120 contacts fluid 134. For example, after the desired volume is filled with fluid 134, source 138 produces energy 140, e.g., broadband ultraviolet radiation, causing fluid 134 to solidify and/or cross-link conforming to shape of a surface 144 of substrate 102 and patterning surface 122, defining a patterned layer 202 on substrate 102, as illustrated in FIG. 2. Patterned layer 202 may comprise a residual layer 204 and a plurality of features shown as protrusions 206 and recessions 208, with protrusions 206 having thickness t₁ and residual layer 204 having a thickness t₂.

The above-mentioned system and process may be further employed in imprint lithography processes and systems referred to in U.S. Pat. No. 6,932,934, U.S. Patent Publication No. 2004/0124566, U.S. Patent Publication No. 2004/0188381, and U.S. Patent Publication No. 2004/0211754, each of which is hereby incorporated by reference.

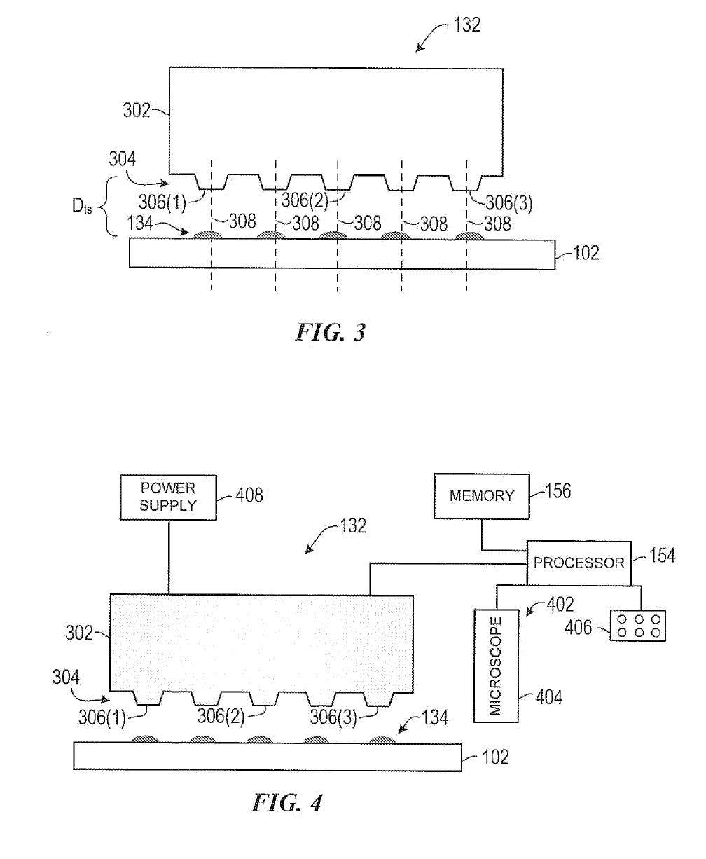

As described above, fluid 134 may be positioned upon substrate 102. Fluid dispensing system 132 may be used to position fluid 134 upon substrate 102. FIG. 3 illustrates a fluid dispensing system 132 comprising a dispense head 302 and a dispense system 304 for positioning fluid 134 on substrate 102. Dispense head 302 may comprise micro-solenoid valves, piezo-actuated dispensers, MEMS based dispensers, ultrasonic base drop ejector, and the like. Piezo-actuated dispensers are commercially available from MicroFab Technologies, Inc., Plano, Tex. To maintain the internal surfaces of dispense head 302, fluid 134 may comprise non-destructive characteristics. For example, in one implementation, fluid 134 comprises a non-corrosive material such that the attributes of dispense head 302 are substantially maintained throughout the dispensing process.

Further illustrated in FIG. 4, fluid dispensing system 132 may include a power supply 408 to provide a voltage V to dispense droplets therefrom. Additionally, fluid dispensing system 132 may be controlled by one or more processors and one or more software generated programs stored in memory. For example, fluid dispensing system 132 may be controlled by processor 154 having a software-generated program stored in memory 156. It should be noted that fluid dispensing system 132 may use an external processor.

When drop dispense methods are used by system 132 to position drops of fluid (e.g., polymerizable material) on substrate 102, fluid parameters may be chosen to facilitate drop formation, ejection and deposition from a dispense head 302. As discussed above, types of fluids that may be dispensed by fluid dispensing system 132 include, but are not limited to, UV-curable resist, heat-curable resist, solvent-based resist, biologically functional liquids, optically active liquids (such as liquids used for organic light emitting devices or OLEDs), electrically active liquids, and the like.

As described above, fluid 134 may be applied to the defined volume between template 108 and substrate 102 using the fluid dispense system 132. The fluid 134 may have a drop placement accuracy on substrate 102 of less than about 20 mrad. Fluid 134 may propagate through dispense head 302 and egresses from tip 306(N) of nozzle system 304. Tip 306(N) defines a dispensing axis 308 at which fluid 134 may be deposited on substrate 102.

Fluid properties may facilitate the drop deposition process and provide short-term and long-term reliability of drop formation and dispense performance. For example, the drop ejection from tip 306(N) may be at a frequency range of greater than about 100 Hertz (Hz) with the formation of individual drop formation of no more than about 100 picoliters (pL). In an implementation, the drop ejection velocity may be at least about 1 m/s.

To promote the fluid 134 to flow through fluid dispensing system 132, the temperature of fluid 134 may be less than about 60° Celsius (C) with a corresponding viscosity of up to about 100 cP and a fluid vapor pressure of less than about 20 Torr. However, in other implementations, the fluid 134 may retain a lower viscosity and fluid vapor pressure as needed to enable the flow and dispensing of fluid 134 through fluid dispensing system 132. Fluid property maybe manipulated by cooling or heating the fluid as long as the activity and functionality is not compromise.

To further promote the flow and deposition of fluid 134, the gradient of velocity of fluid 134, or shear rate, may be up to about 20,000 seconds⁻¹ (s⁻¹) and the surface tension may range from about 20 mN/m to about 35 mN/m. However, in other implementations, the shear rate and surface tension may be lowered or raised as needed to enhance the flow of the fluid 134 through the fluid dispensing system 132.

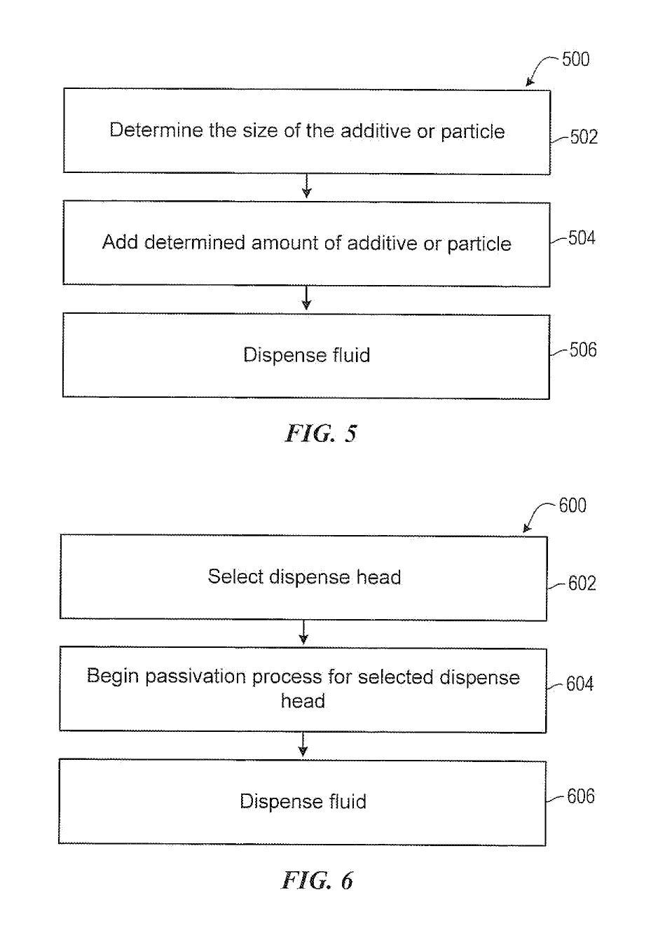

FIG. 5 is a flow chart of an exemplary method 500 for dispensing droplets of fluid 134 to prevent dogging of nozzle system 304. In a step 502, the size of an additive or particle is determined such that the particle size is about 10% or less than the diameter of the tip 306(N) of the nozzle system 304. In a step 504, an amount of additive or particle is added to fluid 134. In one implementation, the amount of additive or particle is less than about 50 wt %. However, in another implementation, an amount of additive or particle may be greater than about 50% provided that there is little or no flocculation in fluid 134. In a step 506, drops of fluid 134 may be dispensed by the nozzle system 304.

When the fluid 134 to be dispensed by fluid dispensing system 132 is a polymerizable material, such as, for example, an imprint resist material, additional fluid properties may further facilitate the drop deposition process. For example, for optimal drop formation and ejection by the fluid dispensing system 132, the polymerizable material may have a viscosity ranging from about 1 to about 20 cP and a surface tension ranging from about 20 mN/m to about 35 mN/m. Further, the use of a polymerizable material with fluid dispensing system 132 may include the use of a 760 GS8 print head, commercially available from Xaar of the United Kingdom. The 760 GS8 print head includes a target volume of about 8 pl. However, in other implementations any dispense head may be used with fluid dispensing system 132.

FIG. 6 is a flow chart of an exemplary method 600 for the passivation of a dispense head 302 in fluid dispensing system 132 for the purpose of inhibiting, or preventing adsorption of one or more functional components from the polymerizable material and/or to prevent passing of contaminates between the dispense head and the polymerizable material within the dispense head 302. In step 602, a dispense head 302 is selected for use with the fluid dispensing system 132 to facilitate drop formation and ejection of the polymerizable material. In a step 604, the dispense head 302 is passivated in relation to the polymerizable material. In one implementation, the process of passivation comprises rinsing the internal wetted pathways of the dispense head 302 with a liquid solution of tridecafluoro-1,1,2,2-tetrahydrooctyl trichlorosilane (C₅F₁₃C₂H₄SiCl₃). Another example of passivating the dispense head is carried out by vapor treatment using parylene coating. In a step 606, drops of the polymerizable material may be dispensed by the fluid dispensing system 132.

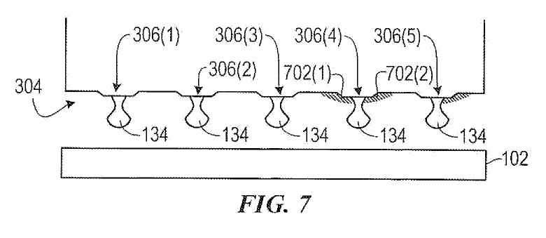

The polymerizable material dispensing from nozzle system 304 may be subject to evaporation due to general air flow about system 100 and/or subjected to crosslinking or gelling when exposed to energy source 138 (as shown in FIG. 1). Evaporation may clog nozzle system 304 resulting in non-dispensing tips 306(N), poor drop placement, filling defects, and the like. For example, FIG. 7 illustrates nozzle system 304 having multiple tips 306(1), 306(2), 306(3), 306(4), and 306(5) for dispensing polymerizable material 134. Evaporated polymerizable material may deposit residue 702(1) and 702(2) adjacent to tips 306(4) and 306(5), respectively. Residue 702(1) and/or 702(2) may interfere or inhibit with drop formation, interfere with drop placement, and/or contaminate polymerizable material that will egress from tip 306(N). In one implementation, to reduce, if not prevent, the evaporation of the polymerizable material, more volatile components are selectively replaced within the formulation with those that will vaporize less. In other implementations, other methods and/or processes may be used to reduce evaporation.

Although embodiments for a fluid have been described in language specific to structural features and/or methods, it is to be understood that the subject of the appended claims are not necessarily limited to the specific features or methods described. Rather, the specific features and methods are disclosed as exemplary implementations.

What is claimed is:

1. A system, comprising:
one or more dispense heads adapted to deliver a fluid to a substrate, the fluid having:
a viscosity of no greater than 100 centipoise;
a surface tension in a range of about 20 mN/m to 35 mN/m; and
a nozzle system coupled to each dispense head, wherein each nozzle of the nozzle system includes a nozzle tip adapted to provide a drop ejection frequency of at least 100 Hz and a drop ejection velocity of at least 1 m/s.

2. The system of claim 1, wherein the fluid is selected from a group consisting of a UV curable resist material, a cured resist material, a solvent base resist material, a biologically functional liquid, an optically active liquid, or an electrical active liquid.

3. The system of claim 1, wherein the fluid further has a shear rate up to about 40000 s⁻¹.

4. The system of claim 1, wherein the fluid has a fluid vapor pressure of no more than 20 Torr.

5. The system of claim 1, wherein the nozzle tip is adapted to provide a drop of fluid having a volume no greater than 100 pL.

6. The system of claim 1, wherein the nozzle tip is adapted to eject the fluid onto the substrate with a placement accuracy of about 20 mrad.

7. The system of claim 1, wherein the fluid has a fluid temperature of no greater than 60 degrees Celsius.

8. The system of claim 1, wherein the system is controlled by at least one of a program stored in a computer-readable storage media and one or more processors.

9. A method, comprising:
determining a passivation process for at least one dispense head of a fluid dispense system;
determining a volatility for a polymerizable material formulation based on the passivation process;
determining a viscosity for the polymerizable material enabling drop formation and ejection based on the passivation process; and
dispensing the polymerizable material through the dispense head.

10. The method of claim 9, wherein the viscosity for the polymerizable material ranges from about 1 to about 20 cP.

11. The method of claim 9, further comprising heating the polymerizable material.

12. The method of claim 9, wherein the polymerizable material has a surface tension ranging from about 20 mN/m to about 35 mN/m.

13. The system method of claim 9, further comprising controlling dispensing of the polymerizable material by at least one of a program stored in a computer-readable storage media and one or more processors.

14. A polymerizable material for dispensing in a system, the polymerizable material comprising:
one or more additives comprising at least 50 wt % of the polymerizable material;
one or more components enabling one or more attributes of an internal surface of a dispense head of the system to be maintained throughout a dispense process; and
a reduced vapor pressure to inhibit deposition of evaporated polymerizable material on one or more nozzles of the system.

15. The polymerizable material of claim 14, wherein the one or more additives are no more than about 10% of a nozzle diameter of each of the one or more nozzles of the system.

16. The polymerizable material of claim 15, wherein the one or more additives produce no flocculation within the polymerizable material.

17. The polymerizable material of claim 14 further comprising a viscosity ranging from about 1 to about 20 cP.

18. The polymerizable material of claim 17, wherein the viscosity and, an associated temperature may be cooled facilitating drop formation and ejection of the polymerizable material and activity or functionality of the material.

19. The polymerizable material of claim 17 further comprising a surface tension ranging from about 20 mN/m to about 35 mN/m.

20. The polymerizable material of claim 15, wherein the vapor pressure has a maximum of 20 Torr.
